(19) United States
(12) Patent Application Publication
(10) Pub. No.: US 2004/0009338 A1
(43) Pub. Date: Jan. 15, 2004

(54) Plastic rail system and other building products reinforced with polymer matrix composites

(76) Inventors: Byeong H. Jo, Blue Bell, PA (US); Richard S. Duncan, Royersford, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/441,530

(22) Filed: May 19, 2003

Related U.S. Application Data
(63) Continuation-in-part of application No. 09/988,985, filed on Nov. 19, 2001.

(51) Int. Cl. B32B 27/04

(52) U.S. Cl. 428/297.4

(57) ABSTRACT

Polymeric building materials are provided which include a composite reinforcement comprising continuous filaments of fibers substantially oriented in at least a first direction within a polymeric matrix. The composite reinforcement includes a higher tensile strength and a lower rigidity than aluminum. The building material further includes a capstock polymeric material disposed substantially over the composite reinforcement. The building material is resistant to heat deformation and corrosion. This invention also includes methods for constructing such polymeric composite building materials, including in the preferred embodiments, pultrusion and extrusion steps.

### CROSS-REFERENCE TO RELATED APPLICATIONS

The present Application is a continuation-in-part of U.S. application Ser. No. 09/988,985, filed Nov. 19, 2001.

### FIELD OF THE INVENTION

The present invention relates to reinforced polymeric building materials, especially those having a composite reinforcement including continuous filaments in a polymeric matrix.

### BACKGROUND OF THE INVENTION

Most fence and rail materials are either traditional lumber or thermoplastics. Typical plastics in these applications are PVC (polyvinyl chloride) and polyethylene. PVC typically does not have the strength and rigidity of lumber and therefore, the rail for the fence and railing needs a steel or aluminum reinforcement channel inside the rail. These metal reinforcements are prone to corrosive attack, and the PVC loses strength in long-term exposure to UV light. Also, a problem exists regarding the dark color of thermoplastic products. A dark color fence rail made of PVC or other polymeric materials has not been successful since it will often experience bowing due to differences in expansion and contraction between the opposite sides of the product upon exposure of sunlight. The top side absorbs more of the sun's rays than the bottom side, creating uneven temperatures. An additional problem is the lack of long-term stiffness of such products. It has limited the rail span between the posts to less than that for traditional lumber.

An attempt to overcome some of the shortcomings of unreinforced polymer structural members has been made by artisans employing pultruded components. See Beck, U.S. Pat. No. 5,839,247, which is hereby incorporated by reference. Beck teaches the use of a pultruded component which can be inserted or affixed to a PVC siding product for supporting same.

Similar attempts have been made to improve sailing booms (U.S. Pat. No. 5,580,626) and signage and marking devices (U.S. Pat. Nos. 5,189,822; 4,571,118 and 4,812,343), all of which are hereby incorporated by reference.

There are two categories of pultrusion products. The first category consists of solid rod and bar stock produced from axial fiberglass reinforcements and polyester resins; these are used to make fishing rods and electrical insulator rods, which require high axial tensile strength. The second category is structural profiles, which use a combination of axial fibers and multidirectional fiber mats to create a set of properties that meet the requirements of the application in the transverse and longitudinal directions.

More than 90% of all pultruded products are fiberglass-reinforced polyester. When better corrosion resistance is required, vinyl ester resins are used. When a combination of superior mechanical and electrical properties is required, epoxy resin is used. Higher temperature resistance and superior mechanical properties generally dictate the use of epoxy resins reinforced with aramid or carbon fibers.

Aluminum extrusions account for approximately 15% of all of the aluminum consumed, while pultrusions account for only 5% of all reinforced plastics produced; thus, pultrusion has much growth potential.

The highest-volume application of pultrusion is the fabrication of nonconductive ladder rails for in-plant and communication utility use. Corrosion-resistant fiberglass sucker rods have replaced steel in the extraction of oil. As stated above, semiflexible highway delineator posts that deflect without permanent deformation are used instead of rigid cold-rolled steel posts with plastic reflectors.

In highly corrosive environments, pultruded grating systems have become the standard because of their durability, replacing steel, aluminum, and even stainless steel systems. They are also used in elevated walkways and on steps where the supports are structural profiles, such as I-beams, channels, angles, and tubular shapes, that are made to the same dimensions as steel or aluminum supports. Cable trays of steel are being replaced by pultruded composite cable trays because of their superior corrosion resistance and better electrical insulation values.

Pultruded solid rectangular and square bars are being used in transformers to separate the windings and to permit air circulation. Utility market applications include guy strain insulators, stand-off insulators, hot-line maintenance tools, and the booms for electrical bucket trucks. Other electrical applications include tool handles, bus bar insulator supports, fuse tubes, and lighting poles.

Dunnage bars that separate and isolate loads in trucks and railcars have been made from pultruded lineals for many years. The back doors that roll into the roof of the truck are usually pultruded, as are the structural Z sections between the inner and outer walls of a refrigerated truck trailer.

In many buses, the luggage rack is pultruded. Hollow sections within the rack allow air to be passed for heating or cooling. Because of its continuous nature, the process produces the rack in one piece to span the length of the bus. In other rapid transit applications, continuous lengths of overboard are pultruded in one piece to cover the current-carrying third rail on rapid transit systems. Because of the design flexibility of composite profiles, the shape is designed to snap over the rail and yet support a load dropped from above.

While composite materials, such as pultruded parts, have found their way into many markets, such products are not widely consumed in the building trade. Part of this reluctance may be cost, but quality concerns, such as alkaline and UV resistance, durability and lower service life perceptions have limited their use.

### OBJECTS OF THE INVENTION

One of the objectives of the present invention is the production of a high strength plastic alternative to the traditional wrought iron or aluminum ornamental rail and fence. Metal fences and rails are constantly under the threat of corrosion attack, and need periodic painting.

Another object of the present invention is to provide a thermoplastic composite product that resembles wrought iron, or aluminum, but which is maintenance-free, kink-free, light and performs at least equally well.

An additional objective is to provide a dark color thermoplastic post and rail fence component (e.g., split post and rails) which is not susceptible to uneven contraction and expansion, in spite of the differences in heat buildup on the surface of the dark color fence component.

A further objective of the present invention is to provide a non-metallic heavy duty rail and fence system for use in industrial and commercial applications. The metallic railing in an industrial atmosphere is often exposed to chemical gases or acids and is prone to corrosion attack. The integrity of the industrial railing is critical for the safety of those in the workplace.

### BRIEF DESCRIPTION OF THE DRAWINGS

This invention will be further described through the following illustrations of preferred embodiments:

FIG. 1 is a front partial view of a fence or railing construction using the preferred composite.

FIG. 2 is a frontal view of a post and rail fence.

FIGS. 3-10 are cross-sectional views of fence rail and post constructions using the preferred composite building materials of this invention.

FIG. 11 is a front partial view of an alternative post and rail fence.

FIG. 12 is a flow chart of an exemplary process for manufacturing a building product according to this invention.

FIG. 13 is a graphical depiction of color change on accelerated weathering showing ΔE vs. hours of exposure.

FIGS. 14-18 are photomicrographs of flat strip samples of composite samples cut from a Prestige™ pultruded rail exposed to a set commercial concrete mix for 0 weeks, 2 weeks, 5 weeks, 8 weeks, and 11 weeks, respectively.

FIG. 19 is a graphical depiction of 3-point bend testing results after accelerated concrete exposure for the samples of FIGS. 14-18, showing lb. force to break vs. sample in time (weeks).

### DESCRIPTION OF THE PREFERRED EMBODIMENTS

In a first embodiment of the present invention, a polymer composite building material is provided, which includes a composite reinforcement comprising continuous filaments of fibers substantially oriented in at least a first direction within a polymeric matrix. The composite reinforcement includes a higher tensile strength and a lower rigidity than aluminum. The building material further includes a capstock polymeric material disposed substantially over the composite reinforcement. The building material is resistant to heat deformation and corrosion.

In a further embodiment of the present invention, a polymeric composite building material is provided which includes a composite reinforcement comprising glass filaments oriented in at least the first direction within a thermoplastic resin matrix, and a capstock polymeric material comprising a thermoplastic resin and a dark pigment melt bonded to the composite reinforcement. The composite reinforcement includes a tensile strength greater than about 180 MPa and a rigidity of lower than about 70 GPa. The capstock polymeric material is resistant to corrosion, to chemical gases or acids, and the building material is resistant to heat deformation due to sunlight exposure.

In still a further embodiment of the present invention, a method of making a polymer composite building material is provided which includes the steps of forming a composite reinforcement comprising continuous filaments of fibers oriented substantially in a first direction within a polymeric matrix, disposing a capstock polymeric material substantially over the composite reinforcement, and cutting the composite reinforcement and overlaying capstock polymeric material to a desired length.

The present invention relates to a consolidated form of commingled continuous filaments of glass fibers and polymeric fibers as a reinforcement. The consolidation of the commingled fibers into a composite reinforcement may be made in-situ during in-line pultrusion and/or extrusion of the final end product or, alternatively, prepared as tape or rod and incorporated into an off-line extrusion or molding of a final product. Alternatively, commingled reinforcing and thermoplastic fibers can be pultruded and overmolded with a capstock polymeric material. In this way, a polymer material encapsulates the inside surface, the outside surface, or both surfaces of the product.

Another production process alternative is to pultrude these commingled fibers through a die, followed by an overlay extrusion of a capstock polymer using a separate extruder, all in-line. In this case, the capstock polymer covers only the outside surface. The commingled fibers are heated prior to entering into the series of forming dies where they are consolidated. In a further embodiment, a helical winding machine may be added in order to enhance the strength in hoop direction before the die entrance.

A preferred material for use in the present invention is Twintex® composite tapes, supplied by Vetrotex CertainTeed, Waco, Tex. The Twintex® materials can be present in various forms, such as commingled roving and fabrics (uni-directional, or multi-axial woven fabric or tapes). The commingled roving can be consolidated through a pultrusion die into a thermoplastic composite tape or rod. Such composites contain glass fibers dispersed uniformly in at least a longitudinal direction. The polymeric fiber that becomes the consolidation matrix may contain, for example, polyethylene (PE), polypropylene (PP) or polyesters (PBT or PET). The functional need of the end product and extrusion process will determine the fiberglass content in the Twintex® material and the volume of the consolidated reinforcement. A “standard” Twintex® material contains about 40%-75% glass fiber content.

Although polyethylene and polypropylene Twintex® tapes and fabric were used in the testing of the present invention, any thermoplastic or thermosetting polymeric materials would be acceptable for commingling a polymer fiber with glass fiber, as long as they are capable of being fiberized and made compatible to the intended matrix and/or capstock polymers.

A further aspect of the present invention relates to the compatibility of the commingled polymeric fiber material with the matrix polymer of the final extrusion product. These materials desirably include adhesion, a melt bond, or an interdiffusional bond, with each other in order to provide optimal mechanical properties to the building product. In the testing of the present invention, a polyethylene-glass fiber Twintex (reinforcement/HMPE (“high molecular weight polyethylene”) polymer, polypropylene-glass fiber Twintex® reinforcement/HMPE polymer, polyethylene-glass fiber Twintex® reinforcement/polyethylene polymer, and polypropylene glass fiber Twintex® reinforcement/polyethylene polymer were used. The combinations of the polymers of the composite reinforcement and the base polymers are numerous, and may be customized in order to meet the needs of the final product performance requirements. The Twintex® composite reinforcement allows for a base polymeric material with a higher impact in both cold and ambient temperatures, lower heat expansion coefficient, higher tensile and flexural strength, as well as higher rigidity. These Twintex® reinforcements (rods, tapes or fabrics) are embedded into strategic locations of the basic polymeric material. In a further preferred embodiment of the present invention, a hybrid of Twintex® filaments with carbon fibers may be utilized, with the combination providing for higher stiffness and easier material handling, as well as providing for a lighter weight product overall.

The materials of the present invention may be manufactured by a pultrusion process, the mechanics of which are familiar to those of skill in the art. One process available for use with this invention utilizes continuous Twintex® fibers (roving or yarn), and other fiber as necessary, in order to process uniaxially reinforced profiles with exceptional longitudinal strength. Modification of the basic process allows for the incorporation of transverse or helical reinforcements, for example, for providing biaxial and torsional strength. Important components of the pultrusion process are: (1) heating, wherein the thermoplastic or thermosetting fibers are melted, and (2) consolidation and shape forming at the tooling die, in which relatively high pressure is involved.

In a further preferred embodiment, the commingled, continuous filaments of glass fibers and polymeric fibers including from about 20%-80% glass fiber content. These commingled, continuous filaments may further, or alternatively, include carbon fibers and/or aramid fibers. Furthermore, a bulk molding compound may be made out of pellets made from the commingled, continuous filaments of glass fibers and polymeric fibers. This bulk molding compound may be compression molded, for example, into particular building products, such as a gate, pipe, trim fence, rail, post, siding panel, roofing shingle, window and door components, and deck materials, their components and accessories.

In a further preferred embodiment of the present invention, the bulk molding compound is diluted with an addition of polymeric pellets to a glass fiber content of 10% or greater in the final product. The thermal expansion and contraction of the composite building material is controlled by the use of the bulk molding compound.

The properties of the preferred materials of this invention are somewhat unexpected, and largely represent an improvement over aluminum and iron fencing currently used commercially. For example, the thermoplastic composite fencing materials of the present invention, even when tinted black, showed virtually no evidence of fading when exposed to approximately 7000 hours of testing in simulated sunlight. In fact, it appeared in some samples that the black appearance of the railing actually improved with age. In gate deflection tests, it was noticed that the commercial embodiment of the present invention, Prestige™ fencing, available from Bufftech, Inc., Buffalo, N.Y., didn't break under load, but returned almost to where it had started, while other gates made of aluminum broke or deflected further and stayed bent. In testing cut samples of Prestige™ fencing for alkaline resistance in cement mixtures, weeks of concrete exposure did not significantly reduce the 3-point bend force to break results.

The commercial embodiment of the present invention also was resistant to scratching when impacted by the cutting string of a motorized trimmer, whereas aluminum and steel black fence versions showed visible scratching. Finally, the polymer composite building materials of this invention can be designed to have a greater flexural strength, but lower rigidity than aluminum, which allows them to absorb impact loads more readily without breaking.

### DETAILED DESCRIPTION OF THE PREFERRED EMBODIMENTS

With reference to the Figures, and particularly to FIGS. 1-11 thereof, a partial post and rail fence 100 is illustrated. As used herein, the term “fencing component” means any fence, rail, gate component, or accessories thereof. The rails 10 and 20 shown in FIGS. 3 and 5, respectively, include composite reinforcements 14 and 15 comprising continuous filaments of fibers substantially oriented in at least a first direction within a polymeric matrix. The composite reinforcements 14 and 15 have a tensile strength which is greater than aluminum, but have a lower rigidity than aluminum. Disposed over the composite reinforcements 14 and 15 is a capstock polymeric material 12 and 13 which is disposed substantially over the composite reinforcements 14 and 15. The rails 10 and 20 can be joined with pickets 11, which can be similarly reinforced, and the ends of the rails are joined to a post. Because of the increased tensile strength over aluminum and PVC fencing, the rails 10 and 20 can have a span of about 8 feet or more. They are additionally resistant to bowing due to expansion and contraction when exposed to sunlight, even when a dark pigment is employed. Preferably, the dark pigment produces a CIE 1976 L*a*b* unit measurement of about 10-20, preferably, about 12-18, and most preferably about 14-17, with a ΔE color change of less than 3 over time.

Alternatively, the rail construction can include a bridging portion, more extensive composite reinforcement 19 and a capstock overlayment 16, as shown in FIG. 4.

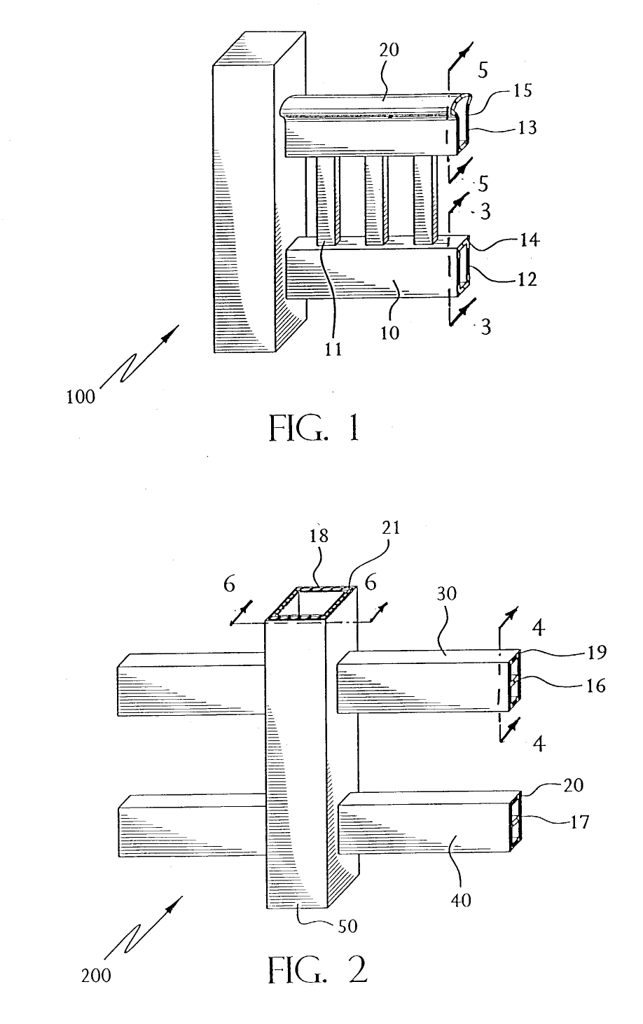

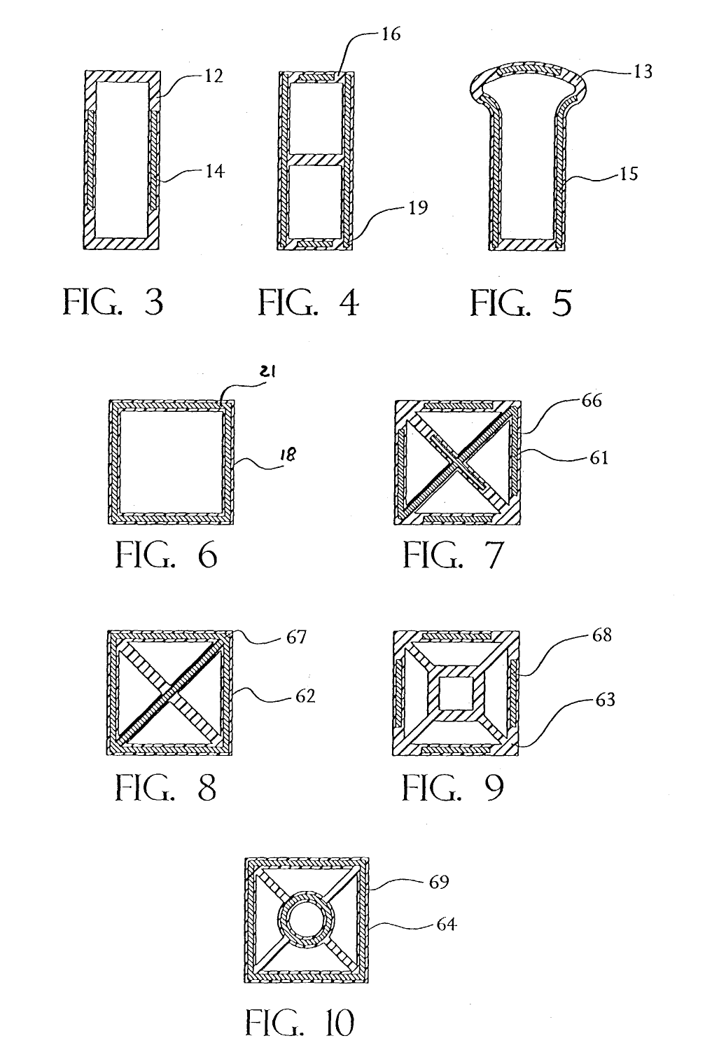

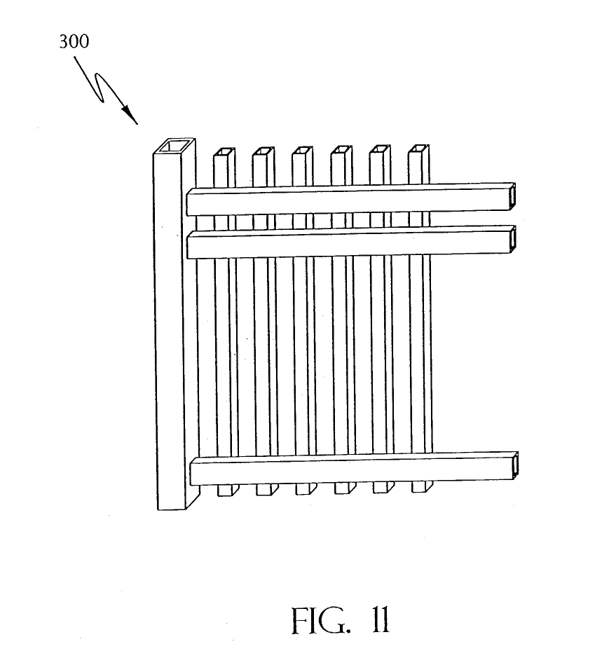

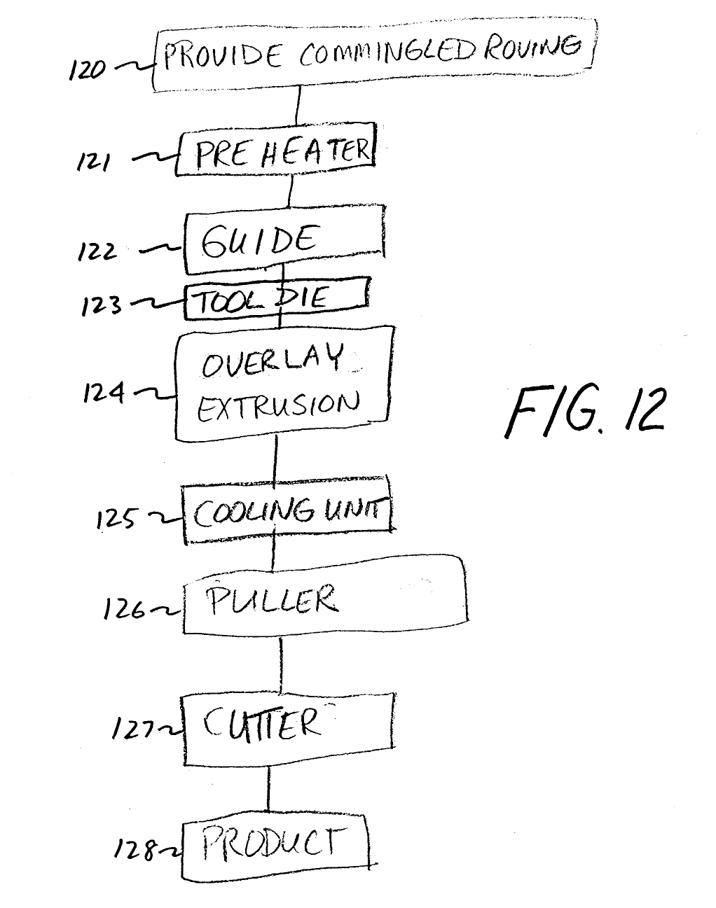

Because of the increased mechanical properties, long spans of railing, such as a rail of more than 8 feet in span between two posts, can be provided. In one example, a pair of 16 foot length rails 30 and 40, disposed between three or more posts 50, can be provided using the greater reinforced rail of FIG. 4. The post 50 includes composite reinforcement 21 and capstock 18. In an alternative embodiment for the post of either FIG. 1 or 2, segmented composite reinforcement 66 in a generally “Z” orientation could be employed with capstock 61, as shown in FIG. 7. FIG. 8 shows an alternative construction with composite reinforcement 67 having a square and a diagonal reinforcement within capstock 62; a cube within a cube configuration with segmented composite reinforcement 68 and capstock 63, as shown in FIG. 9; and a circle within a square having a circle shaped and square shaped composite reinforcement 69 capped with capstock 64, as shown in FIG. 10. Many other reinforcement and capstock geometries can be envisioned which are equally suitable for this invention.

In still a further embodiment of this invention shown in FIG. 11, an alternative post and rail fence 300 is provided in which multiple rails are suspended between two or more posts, and a plurality of pickets are affixed to the rails.

The composite reinforcement can be oriented, such as by pultrusion, but may also be manufactured as a bulk molding compound (BMC) with more or less randomly oriented fiber lengths of from about 3/16 inch to 2 inches. These long fibers and polymeric matrices may be further processed by compression molding, for example, or through an extruder and die that is specifically designed for processing of long fiber reinforced plastics. These BMC compounds can be diluted with other polymeric pellets depending on the need of processability, functional demand or cost reduction.

The preferred materials for use in connection with the polymer matrices of the composite reinforcements, for example, reinforcements 14, 15 and 19, and the capstock, for example capstock 12, 16, 13 and 63, will now be described. All of the building products of this invention contain resinous materials, such as thermoplastic and thermosetting resins. A preferred thermoplastic material for the building materials of this invention is polypropylene, but polyethylene and polyesters also show promise. With various plasticizers, fillers, stabilizers, lubricants, impact modifiers and other additives, thermoplastics and thermosetting polymers can be compounded to be flexible or rigid, tough or strong; to have high or low density; or to have any of a wide spectrum of physical properties or processing characteristics. These resins can also be alloyed with other polymers, such as ABS, acrylic, polyurethane, and nitrile rubber to improve impact resistance, tear strength, resilience, or processability. They can also be produced water-white in either rigid or flexible compositions, or they can be pigmented to almost any color, preferably black.

### Composite Reinforcement

The preferred composite reinforcements, 14, 15, 19, 21, 61, 67, 68 and 69 of this invention will now be more fully disclosed. Un-reinforced engineering thermoplastics typically have a tensile strength in the range of about 55-100 MPa (8×10³ to 15×10³ psi). The workhorse of engineering resins, unreinforced nylon 6/6, has a tensile strength of about 83 MPa (12×10³ psi) and a tensile modulus of about 34 GPa (5×10⁶ psi). However, unlike metals, such as aluminum or steel, the stiffness in plastics is guided by their flexural modulus.

It is known that by reinforcing thermoplastics and thermosets, the stiffness of these resins can be dramatically increased. Short glass fibers at 5-30% (by weight) boost the tensile strength of engineering plastics by about a factor of two; longer glass fibers or carbon fibers, even further.

On the high end of the composite material spectrum are advanced polymer matrix composites (“PMCs”). Reinforced with high-modulus and high-strength fibers, a unidirectional laminate can have a tensile modulus of about 140-200 GPa (20-29×10⁶ psi) and a tensile strength of about a 1,100-1,600 MPa (165-225×10³ psi). Reinforcing fibers for advanced composites include boron, S-glass, E-glass, carbon fibers, graphite, long glass, and aramid fibers, particles, or pulp.

Advanced PMCs have higher specific strength and stiffness than most metals, and the ability to selectively place fibers for design versatility, and have a higher tensile strength and lower stiffness than aluminum. Varying fiber orientation, concentration, and even generic fiber type, permits tailoring of stiffness and strength to a specific application. Braiding, helical winding and weaving of the reinforcements have also been used to produce stronger components. Techniques using unreinforced liquid-crystal polymers (LCPs), UHMWPE, ceramic, high strength graphite fibers, polyphenylene benzobisthiazole (PBT) fibers, polyphenylene benzobisoxozole (PBO) fibers, and/or particles, have also produced high strength polymer-matrix-composites with environmental stability.

The preferred building materials of this invention contain thermoplastic matrices and materials. Preferred resins can contain, for example, thermoplastic polypropylene, polyethylene, polystyrene, PVC, polyimides, polyesters, and nylons. Because of their inherently faster processing (no time-consuming curing or autoclaving) thermoplastic matrix-composites have some attractive qualities over thermoset composites. Some current examples of processing techniques include lamination, filament winding, and pultrusion. Thermoforming, hot stamping of consolidated sheet, and roll forming processes are also promising techniques for producing the composite reinforcements of this invention.

The comparison of the mechanical properties for selected polymer-matrix-composites, un-reinforced polyvinyl chloride, thermoplastic steel and aluminum is shown below in Table I.

TABLE I
Mechanical Properties of Polyvinyl Chloride, Unidirectional
Advanced PMCs, Glass Fiber-Reinforced PMCs, Steel,
and Aluminum

| | Tensile | Tensile | Flexural | Flexural |
|---|---|---|---|---|
| | Strength, x | Modulus, x | Strength, x | Modulus, x |
| | 10³ psi | 10⁶ psi | 10³ psi | 10⁶ psi |
| Boron/Epoxy | 199 | 29.2 | — | — |
| Boron/Polyimide | 151 | 32.1 | — | — |
| S-Glass/Epoxy | 187 | 8.8 | — | — |
| High Modulus | 122 | 27.5 | — | — |
| Graphite/Epoxy | | | | |
| High Modulus | 117 | 31.3 | — | — |
| Graphic/Polyimide | | | | |
| High Strength | 218 | 21.0 | — | — |
| Graphite/Epoxy² | | | | |
| Aramid/Epoxy³ | 172 | 12.2 | — | — |
| High-Strength | 220 | 16.0 | — | — |
| Graphic/Epoxy⁴ | | | | |
| Polyvinyl Chloride (Rigid) | 7.5 | 0.6 | — | — |
| Polyvinyl Chloride (Flexible) | 1.5 | — | — | — |
| Glass/Comp. Molded | 6.0 | 1.75 | 12.8 | 1.58 |
| Polyester BMC⁴ | | | | |
| Glass/Inj. Molded | 4.86 | 1.53 | 12.65 | 1.44 |
| Polyester BMC⁴ | | | | |
| Glass/Comp. Molded | 23.0 | 2.27 | 45.0 | 2.0 |
| Polyester SMC⁵ | | | | |
| Glass/Comp. Molded | 12.0 | 1.7 | 26.0 | 1.6 |
| Polyester SMC⁵ | | | | |
| Glass/Comp. Molded | 5.3 | 1.7 | 16.0 | 1.4 |
| Polyester SMC⁵ | | | | |
| Glass/Polyester | 30.0 | 2.5 | 30.0 | 1.6 |
| Pultrusions | | | | |
| Glass/Filament-Wound | 80.0 | 4.0 | 100.0 | 5.0 |
| Epoxy | | | | |
| Glass/Polyester, | 12.5 | 1.0 | 27.0 | 0.75 |
| Spray-Up/Lay-Up | | | | |
| Glass/Polyester, | 37.0 | 2.25 | 46.0 | 2.25 |
| Woven Roving (Lay-Up) | | | | |
| Cold-Rolled, | 48.0 | 30.0 | — | — |
| Low Carbon Steel⁶ | | | | |
| Wrought Aluminum | 49.0 | 10.2 | — | — |

¹Property values shown are in longitudinal direction;
²UNION CARBIDE THORNEL T-300 fibers;
³DUPONT KEVLAR 49;
⁴Bulk molding compound;
⁵Sheet molding compound;
⁶SAE 1008.

As shown by the embodiments described in FIGS. 1-10, it is understood that the composite reinforcement of this invention can be inserted in apertures along the building materials, adhered to an inwardly-facing surface of the building materials, and/or molded, pultruded or extruded integrally with these products to reinforce them at a single location, or at multiple locations along their length or width.

One of the more interesting composite manufacturing techniques useful for this invention is pultrusion. Pultrusion is an automated process for manufacturing composite materials into continuous, constant cross-sectional profiles. It is probably one of the most versatile composite processes, but it is still one of the least understood.

The term pultrusion refers to the final product and to the process. Most simply, it refers to a nonhomogeneous compilation of materials pulled through a die. In virtually every case, a continuous reinforcing fiber is integral to the process and the finished product.

Of the six key elements in the pultrusion process, the three that precede machine operation are a reinforcement handling system (referred to as creels), a resin impregnation station, and the material forming area. The machine consists of component equipment that heats, consolidates, continuously pulls, and cuts the profiles to a desired length. Although machines can produce profiles that range from 25 mm (1 in.) to 3 to 5 m (10 to 15 ft) per minute, typical line speeds are in the range of 0.6 to 1.2 m/min (2 to 4 ft/min) per cavity.

As shown in the preferred process of FIG. 12, the process begins when commingled roving (Twintex®, polypropylene and textile glass commingled fibers) are provided at step 120. The commingled fibers proceed through a preheater step 121, where the commingled polypropylene fibers begin to melt and consolidate with the glass fibers to coat them, wholly or partially. The resin-impregnated fibers are preformed in a guide at step 122 to help shape the profile to be produced. This composite material is placed in a heated steel die at step 123 that has been precision machined to the near net shape of the composite reinforcement to be manufactured. (Heat initiates an exothermic reaction if a thermosetting resin matrix is chosen for the reinforcement.) The profile is continuously pulled through an overlay crosshead extruder at step 124, at which the capstock is applied. The overmolded composite exits the mold as a hot, constant cross-sectional profile, such as a rail 20, post 50 a roofing shingle, a siding member, or the like. The profile cools in ambient or forced air, or is assisted by water, at step 125, as it is continuously pulled by a mechanism that simultaneously clamps and pulls at step 126. The product emerges from the puller mechanism and is cut at step 127 to the desired length by an automatic, flying cutoff saw, resulting in the final product at step 128.

Pultruded composites exhibit all of the features produced by other composite processes, such as high strength-to-weight ratio, corrosion resistance, electrical insulation, and dimensional stability. Additional advantages, inherent in this process, include the capability that any transportable length can be produced, because of its axial nature, including small-diameter tubes, or rods that can be 2.2 km (1.4 miles) long, which can be wound on a spool after pultrusion.

Another advantage is that complex, thin-wall shapes, such as those extruded in aluminum, or polyvinyl chloride (PVC), are now possible because of disclosed process technology advances. Hollow sections can be produced by using cantilevered steel mandrels (not shown).

A third advantage is that wire, wood, or foam inserts can be encapsulated on a continuous basis in pultruded products. In addition to symmetrical walls, which are always easier to pultrude, variable wall thicknesses in a constant cross section can be pultruded, such as shown in FIG. 7, for example.

A fourth advantage of the process, which is less obvious, is its ability to use a wide variety of reinforcement types, forms, and styles with many thermoplastic or thermosetting resins and fillers. Reinforcements can be placed precisely where they are needed for mechanical strength and the process can be consistently repeated.

Finally, pultruded shapes can be made as large as required because equipment can be built in any size. A corollary advantage of larger equipment is its ability to produce multiple cavities of the same or different profiles. The cost of dies for pultruded shapes is also low compared to other composite processes.

The basic elements of all pultrusion machines are very similar, but there are differences in the selection of heating components, drive trains, clamping devices, and cutoff saws.

Reinforcements are provided in packages designed for the best continuous run-out of its material form. Continuous glass rovings or commingled plastic and glass fibers are provided in center-pull packages that weigh 15 to 25 kg (30 to 50 lb) and are designed for a bookshelf-style creel. Creels of 100 or more packagers are common and may be stationary or mobile. The glass-plastic commingled fiber is usually drawn from the package through a series of ceramic textile thread guides or drilled carding plates of steel or plastic. This allows them to be pulled to the front of the creel while maintaining alignment and minimizing fiber breakage. Some creel designs allow multiple guide eyes (bushings) or guide bards to tailor the tension to each roving. The ease of servicing or replacing roving packages must be considered in selecting a creel design and package capacity.

As materials travel forward toward the preheater step 121, it is necessary to control the alignment to prevent twisting, knotting, and damage to the reinforcements. This can be accomplished by using creel cards that have predefined specific locations for each material. In some cases, these cards can be used for only one profile. In other cases, a general format for roving and web locations can be easily adapted for a variety of common profiles.

The impregnation of reinforcements with liquid resin is basic to nearly every pultrusion process. The point at which resin is supplied and the manner in which it is delivered can have many different forms. A dip bath is most commonly used. In this process, fibers are passed over and under wet-out bars, which causes the fiber bundles to spread and accept resin. This is suitable for products that are of all-roving construction or for products that are easily formed from the resulting flat ply that exits the wet-out bath. In cases in which it is impractical to dip materials into a bath, such as when vertical mats are required or hollow profiles are made, materials can pass directly into a tailored resin bath through bath walls and plates that have been machined and positioned to accommodate the necessary preform shape and alignment. This alternative method provides the necessary impregnation without the need to move the reinforcements outside of their intended forming path. In the preferred methods of fabrication described by this invention, Twintex® commingled polypropylene and glass textile fibers are preheated either by induction heating, heated lamps or an oven, for example, to help melt and consolidate the polypropylene with the glass fibers. This consolidation step, in effect, eliminates the need for a dip bath or a separate impregnation step, since the Twintex® commingled fibers are relatively self-impregnating.

Forming is usually accomplished after impregnation, although some initial steps can be carried out during the impregnation process. Forming guides are usually attached to the pultrusion die to ensure positive alignment of the formed materials with the cavity. In the case of tubular pultruded products, a mandrel support is necessary to extend the mandrel in a cantilevered fashion through the pultrusion die step 122 while resisting the forward drag on the mandrel. Materials must form sequentially around the mandrel in an alternating fashion to prevent weak areas due to ply overlap joints. Sizing of the forming guide slots, holes, and clearances must be done to prevent excess tension on the relatively weak and wet materials, but must allow sufficient resin removal to prevent too high of a hydrostatic force at the die entrance.

As an alternative or supplement to the impregnating and forming steps, the preferred method includes injecting a capstock resin directly into a cross-headed extruder during or after the tool forming step 123. The overlay extrusion step 124 can coat one or more composite reinforcements made by the disclosed pultrusion process, or by other methods of composite manufacture, or both. If the overlay extrusion step is performed on heated or partially molten composites, a preferred molecular, interdiffusional, and/or melt bond can be established.

The materials commonly used for forming guides include Teflon, ultrahigh molecular weight polyethylene, chromium-plated steel and various sheet steel alloys. The pultrusion processor who employs a craftsman capable of converting sheet metal and plastic stock into forming guides with precise control would be most successful in processing complex shapes.

A number of different methods can be used to position and anchor the pultrusion die and to apply the heat necessary to initiate the consolidation reaction, in the case of thermosets. The use of a stationary die frame with a yoke arrangement that allows the die to be fastened to the frame is the simplest arrangement. In all die-holding designs, the thrust that develops as material is pulled through the die must be transferred to the frame without allowing movement of the die or deflection of the frame. With this yoke arrangement, heating jackets that use hot oil or electrical resistance strip heaters are positioned around the die at desired locations. Thermocouples are placed in the die to control the level of heat applied. Multiple, but individually controlled, zones can be configured in this manner. This approach is well suited to single-cavity set-ups, but it becomes more complex when the number of dies used simultaneously increases because each die may need a heat source and thermocouple feedback provision. Standard heating jackets can be used, and heating plates can be designed to accommodate multiple dies to help alleviate this limitation.

Another popular die station uses heated platens that have fixed zones of heating control with thermocouple feedback from within the platen. The advantage of this method is that all dies can be heated uniformly with reduced-temperature cycling, because changes in temperature are detected early at the source of heat rather than at the load. In the same respect, however, a temperature offset will be common between the platen set point and the actual die temperature. With knowledge of the differential, an appropriate set point can be established. When provided with the means to separate the platens automatically, the advantage of quick set-up and replacement of dies can lead to increased productivity through reduced downtime.

A source of cooling water or air is desirable in the front of the die at start-up and during temporary shutdown periods to prevent premature gelation of the resin at the tapered or radiused die entrance. This can be accomplished by using either a jacket or a self-contained zone within the heating platen. Alternatively, the first section of the die can be unheated, and cooling can be accomplished through convection. The most critical pultrusion process control parameter for thermosets is the die heating profile because it determines the rate of reaction, the position of reaction within the die, and the magnitude of the peak exotherm. Improperly cured materials will exhibit poor physical and mechanical properties, yet may appear identical to adequately cured products. Excess heat input may result in products with thermal cracks or crazes, which destroy the electrical, corrosion resistance, and mechanical properties of the composite. Heat-sinking zones at the end of the die or auxiliary cooling may be necessary to remove heat prior to the exit of the product from the die. Of course, this is not a problem for thermoplastic matrices or capstocks, which do not need heat to, cure, and merely solidify on their own.

To increase process rates and to reduce temperature differentials that contribute to thermal cracking in large mass products, it is desirable to deliver heat to the material at step 121 before it enters the die. This can be accomplished by radio frequency preheating, induction heating, heat lamps, or conventional conductive oven heating. Such heating devices are available as either integral units or stand-alone devices, which can be positioned before the die entrance.

A physical separation of 3 m (10 ft) or more between the overlay extruder step 124 and the pulling step 126 is generally provided in order to allow the hot, pultruded product to cool in the atmosphere or in a forced water or air cooling stream in step 125. This allows the product to develop adequate strength to resist the clamping forces required to grip the product and pull it through the die. The pulling mechanisms are varied in design among the hundreds of machines built by commercial machinery firms. Three general categories of pulling mechanisms that are used to distinguish pultrusion machines are the intermittent-pull reciprocation clamp, continuous-pull reciprocating clamp, and continuous belt or cleared chain.

Every continuous pultrusion line requires a means of cutting product to length, like cutting step 127. Many systems employ manual radial arm saws or pivot saws on a table that moves downstream with the product flow. More sophisticated automatic cutoff saws are found on commercial machines; this eliminates the need for operator attention. Both dry-cut and wet-cut saws are available, but regardless of design, a continuous-grit carbide- or diamond-edged blade is preferably used to cut pultruded products.

Resin selection for the composite reinforcement and capstock is important because it governs mechanical characteristics, operating temperature range, electrical insulation, corrosion resistance, and the flame and smoke properties of the profile. In addition, it governs process speed by its reactivity and can significantly control product aesthetics and tolerance capability. Resin selection can also influence interlayer adhesion. The resin matrix can be altered by chemical additives and fillers, which enhance its ability to handle higher temperatures, provide better electrical insulation and corrosion resistance, and lessen flame and smoke propagation. It is essential to the success of any composite reinforcement that the polymer matrix be correctly engineered to meet the desired end-use properties and still account for those processing characteristics that are necessary to fulfill the economic goals of the application.

Reinforcements

A composite is, by definition, a combination of reinforcing fibers surrounded by a stress-transferring medium or “matrix” that allows the development of the full properties of the reinforcing fibers. The level of properties developed within a volume can be described approximately by the rule of mixtures, which, simply stated, predicts the resultant properties displayed in any direction to be proportional to the volume fraction of fibers aligned in that direction.

The most widely used reinforcement has been and will continue to be glass fibers, because they are readily available and are low in cost. Electrical grade E-glass fibers, the most common, exhibit a tensile strength of approximately 3450 MPa (500 kpsi); practical, commercial tensile strengths of 200 to 300 kpsi; and a tensile modulus of 70 GPa (10.5×10⁶ psi), but they have relatively low elongations of 3 to 4%. These properties result in composites with high strength and elastic limits, but virtually no yield up to ultimate failure—typically brittle fracture. A variety of fiber diameters and yields are available for specific applications. Glass fiber surface sizing chemistry has been developed over many years to provide optimum wet-out and chemical bonding between the fibers and matrix resins, thus ensuring maximum strength development and retention.

Higher tensile strengths can be achieved with S-glass fibers, which were developed for high-performance applications. These fibers exhibit a tensile strength of 4600 MPa (665 kpsi) and a tensile modulus of 85 GPa (12.5×10⁶ psi). Far greater stiffness can be achieved by using carbon fibers when their conductive nature would not be detrimental to the application.

Carbon fibers are produced from a process of continuous graphitizing and stretching of a textile thread, such as polyacrylonitrile (PAN). The resultant fiber exhibits tensile strength from 2050 to 5500 MPa (300 to 800 kpsi) and tensile modulus from 210 to 830 GPa (30 to 120×10⁶ psi) with elongations of 0.5 to 1.5%. Normally, if high tensile strength is chosen, a lower tensile modulus must be accepted, and conversely. These fibers deliver unique properties, such as electrical conductivity, slightly negative thermal coefficient of expansion, high lubricity, and low specific gravity (1.8 versus 2.60 for E-glass). The price of carbon fibers is often the only limitation to their widespread use.

High-modulus organic fibers, such as the aramids, are an attractive option for providing high tensile strength and modulus of 2750 MPa (400 kpsi) and up to 130 GPa (19×10⁶ psi), respectively, with elongations of up to 4%. This results in very tough composites that exhibit good flexural and impact strengths, which are well suited to ballistic applications and whenever energy absorption is necessary. The low specific gravity (1.45) of these fibers gives them one of the highest strength-to-weight ratios of any reinforcement available. Deficiencies in compressive strength and interlaminar shear strength are being addressed through improved surface chemistry.

Other organic fibers are also available for the composite reinforcements of this invention. Polyester fibers with appropriate binders have been used as a replacement for glass in applications that would benefit from increased toughness and impact resistance but where tensile and flexural strengths can be sacrificed. These fibers provide a low-modulus capability to composites, thus bridging the gap between thermoplastics and glass-reinforced thermosets. With low specific gravity and only a moderate cost premium over glass, these fibers are well suited for certain commercial and industrial applications. Nylon fibers increase the low-cost organic fiber options. A highly oriented polyethylene fiber geared toward higher specific strengths (high properties with low specific gravity) can compete with the aramids in applications requiring stiffness, toughness, and light weight.

Orientation Options

Once the fiber type has been selected, the next most important consideration is the ability to orient it in the desired direction to utilize its properties more advantageously.

The most common and lowest-cost form of continuous reinforcement is roving, which consists of continuous axial filaments in single- and multiple-strand configurations. Glass rovings are designated by their yield, which is defined by the number of yards per pound of material or by the European designation, TEX, in grams per kilometer. The two most commonly used yields are 112 yd/lb and 56 or 62 yd/lb, which is the larger tow of the two. The rovings are typically supplied in 20-kg (40-lb) hollow cylindrical packages with a center pay-out that allows them to be stacked on a multiple-shelf (bookshelf) creel configuration. A similar package is available for the organic fibers previously described. Carbon fiber rovings, however, are provided in sizes designated by the number of filaments per tow, with the most common being 3K, 6K, and 12K filaments. The tow sizes are considerably smaller than the glass roving tow, and the package weights are 0.9 to 2 kg (2 to 5 lb), with an outside pay-out designed for a spindle-style creel system. This difference in material form, although of no consequence in the end product, does present some limitations to the processor with regard to creel style and capacity, splicing frequency, and product size limitations. The recently developed larger tow options (40K, 160K, and 320K) will be of benefit to pultruders.

The roving form allows maximum packing of fibers within a volume to yield the highest possible properties along the product axis, referred to as the longitudinal or machine direction. Maximum axial property development may be diminished by such factors as incomplete wet-out, improper fiber alignment, fiber damage due to creel or forming fixtures, and catenary (uneven fiber-to-fiber tension resulting in loops or nonparallel strands). Given near-perfect alignment, fiber fractions of 65 vol % are achieved (80 wt % for glass fibers). In such a product, there are no fibers oriented in the transverse direction (90° to the longitudinal axis); the strengths exhibited in this direction reflect the strength of the matrix resin only.

To overcome this transverse strength deficiency, reinforcing fibers aligned in the transverse or helical direction can be provided. Continuous-strand mat, which has fibers oriented randomly in all directions, can be used. These fibers are then held together with a thermoset resin binder, which allows the mat to have sufficient tensile strength for processing.

Several mat styles can be used, but the most common is an E-glass mat that has fairly coarse fibers in an open or porous construction but provides high structural efficiency. This mat is used on exterior surfaces and as a center ply to build a laminate with substantially improved transverse physical properties. The porous construction, however, results in a potential for composite surface porosity and provides a very noticeable fiber pattern. When this is unacceptable, a fine-filament A-glass mat (or veil) is used as a surfacing ply to bring more resin to the surface and to achieve a dense, aesthetic surface appearance. Recent strength improvements in fine-filament mats have allowed their use throughout the composite. Regardless of mat style, the processor depends on the mat manufacturer to provide control over fiber distribution, binder content and distribution, and defects that have a serious impact on processing efficiency.

Random-fiber mats are generally used in weights of 0.15 to 0.60 kg/m2 (0.5 to 2.0 oz/ft2). To accommodate the volume required by this lower bulk density type of reinforcement, it is sometimes necessary to remove fibers from the longitudinal direction. The resultant composite will have a slightly lower overall fiber content by volume because more resin is consumed to fill the open-structure mat described. The resultant increase in transverse and off-axis strengths is accompanied by a decrease in longitudinal properties. It is here that the engineer can exercise control over fiber proportions to achieve the properties necessary for the specific application. One restriction dictated by the nature of composites is the need to provide a symmetrical composite ply structure relative to the centerline of the thickness in order to prevent dimensional problems resulting from differential shrinkages of the plies of different reinforcement forms and styles.

Within the limits of design, mats and rovings are the most common structural composite constructions, with typically 50 wt % fiber. By exercising control of the proportions, however, the overall fiber weight content can be varied between 20 and 80 wt. %, and preferably about 40-75 wt. %. Mat construction is also available with carbon fibers having a fine-filament construction.

Although the random-fiber orientation of a mat provides fiber orientation in all directions, a specific volume of fibers can be oriented transverse to the axis by means of several biaxial fabric reinforcement styles. The traditional material used had been woven roving; however, problems associated with weave stability, wet-out, and ply edge fiber retention limited the effectiveness of this material. The introduction of nonwoven biaxial fabrics employing fibers stitched or knitted together at the interstices has provided an effective solution to the problems mentioned above. The stitched fabrics can be supplied with any proportion of longitudinal to transverse orientation—even to the point of having a 100% transverse fiber continuous ply with only longitudinal stitch fibers. These materials are available from a number of suppliers employing various techniques to ensure fiber directional stability, ply integrity, and thickness and weight control.

The biaxial fabrics are generally introduced as internal plies and used in conjunction with a mat as exterior plies. Although not impossible, the use of these materials as exterior plies is somewhat limited because of the tendency for the transverse fibers to be dragged back by friction at the die surface. Additional problems of splicing and fabric skewing make the use of these materials more of a challenge to the processor.

Multiaxis fabrics typically employing 0, 90, and ±45° orientation have become available and provide additional directional strength as well as an improved level of fabric stability. Double-bias fabrics of ±45° without some 0° (or axial) fiber orientation for pulling strength and stability are impractical for pultrusion. However, one may overcome this limitation by stitching fibers to a carrier ply of polyester veil or continuous mat.

In all of these multidirectional fabric styles, the supplier has the versatility of using every fiber type previously described in any or all of the directions possible or in an alternating fashion to provide hybrid composites with tailored properties. The challenge to the design engineer becomes the identification of the most cost-effective style of reinforcement to use in an application not satisfied by the conventional mat/roving construction.

Because of the tendency toward ultraviolet degradation of the surfaces of composites used outdoors, a condition known as fiber bloom will occur over time. This term refers to the exposure of fibers at the surface, which can be an irritant to human contract as well as an aesthetic detraction. To resolve this problem, a capstock is used. Alternatively, surfacing fabrics of organic fiber composition, primarily polyester and nylon, can be used. The capstock or surfacing fabrics are available in a variety of colors, resins, weights and constructions and provide a corollary advantage of possibly contributing to the corrosion resistance, scuff and scratch resistance, impact strength and toughness of the composite. They also help the processor from the standpoint of providing a tough material to assist in carrying materials through the die while protecting the die wall from the abrasive glass. The ability to provide a smooth resin-rich surface appearance without fiber patterns and the ability to be screen or roll printed with company logos, information, wood grains or other cosmetic effects, makes these materials an important element in many pultrusion composite designs.

Matrix Choices

Although the fiber type, form, and style determine the ultimate strength potential, the matrix resin of the composite reinforcements determines the actual level of properties realized through effective coupling and stress transfer efficiency.

Thermosetting resins are the most common matrix resin for composites. Unsaturated polyester resins are often used in composite reinforcements, such as pultrusion. Orthophthalic, isophthalic, and teraphthalic acids or anhydrides, in combination with maleic anhydride and various glycols, are the basic elements. When additional performance is required in the areas of corrosion resistance and elevated-temperature mechanical properties, vinyl esters are available as an alternative to polyesters. Epoxy resins are used when physical properties of the highest level, as well as elevated temperature property retention, are required, which is often the case in military and aerospace applications. A variety of resin alternatives beyond the traditional three mentioned above have been in development in recent years. Resins based on methyl methacrylate are quite promising because they offer the advantages of higher physical properties, high filler loading due to low viscosities, rapid processing speeds, smooth low-profile surfaces, and improved flame-retardant and weathering characteristics. Phenolic resins that are suitable for pultrusion are also possible.

A great deal of interest has developed in recent years in using thermoplastic resins as the matrix for pultruded profiles. The major driving force comes from the desire for improved toughness and postprocessing formability. The thermoplastic matrix reinforcements are desirably in the form of thin tapes or small-diameter rods, which are then used as molding materials in subsequent processing methods, such as pultrusion, coextrusion compression molding. This invention desirably employs commingled reinforcing and thermoplastic fibrous blends, such as Twintex® pellets, fabric or yarn, available from Vetrotex-CertainTeed, such as a 90 wt % glass fiber roving, 10 wt % polypropylene matrix fiber, which is preheated and overmolded or, in the preferred process, coextruded with a polypropylene capstock in a crosshead extruder. All liquid resin systems can be tailored to provide specific performance by using additives. Fillers often constitute the greatest proportion of a formulation, second to the base resin. The most commonly used fillers are calcium carbonate, alumina silicate (clay), and alumina trihydrate. Other fillers, such as mica, talc, calcium sulfate, and various glass beads and bubbles, are offered to the industry for their specific property modification qualities, although they represent a small portion of total use. Fillers can be incorporated into the resins in quantities up to 50% of the total resin formulation by weight (100 parts filler per 100 parts resin).

Wetting agents have been developed that offer the incorporation of a greater filler volume without increasing formula viscosity. These wetting agents can be added to the filler by the supplier or as an additive by the formulator. Air release agents are added in the same respect, that is, to provide more efficient packing by reducing entrapped air in the liquid resin and void content in the finished product.

Special-purpose additives would include ultraviolet radiation screens for improved weatherability, antimony oxide or boric acid for flame retardance (used in combination with or without halogenated resins), pigments for coloration, and low-profile agents for surface smoothness and crack suppression characteristics. A variety of options are available in each of these material categories.

Pultrusion formulations using thermosets typically further employ a multiple-catalyst system to provide rapid low-temperature initiation, followed by midrange accelerator and high-temperature completion. This additive is not necessary for thermoplastic resins.

Mold releases are important in the development of adequate release from the die wall to provide smooth surfaces and low processing friction.

The great amount of latitude that exists in selecting reinforcement type, form, style, and proportion allows a broad spectrum of mechanical properties. The directionality of strength in a pultruded composite can be greatly influenced by substituting longitudinal reinforcement for random mat or directional fabrics. A product with only longitudinal reinforcement will typically exhibit mechanical properties that are at least ten times greater than the same property measured 90° from the longitudinal fibers. In this type of composite, the properties of the fiber dominate the axial properties, but the properties of the resin dominate the transverse properties. As the volume fraction of fibers in the off-axis direction is increased, the longitudinal volume fraction, by necessity, must decrease; thus, the transverse properties are increased at the expense of longitudinal properties. This substitution method can be used to move the directionality of strength toward a one-to-one ratio, or even to the extent of achieving higher transverse properties when using some of the weft transverse orientation fabrics available.

The absolute value of the specific property desired will depend on the fiber type chosen: glass, carbon, aramid, or organic fibers. The magnitudes of typical properties for glass-reinforced pultrusions are given in Table 2 to illustrate the effect of orientation on property levels.

TABLE 2
General properties of fiberglass-reinforced pultruded products

| | Property(a) | | | | | | | | | | | | | | |
|---|---|---|---|---|---|---|---|---|---|---|---|---|---|---|---|
| | | | | | | | | Compressive | | Dielectric | | Thermal | | Coefficient | Water |
| | | Tensile | | Tensile | | Flexural | | strength, | | strength, | | conductivity | | of thermal | absorp- |
| | Specific | Strength | | Modulus | | Strength | | axial | | parallel | | | Btu-in./ | expansion, | tion, |
| Material | gravity | MPa | kpsi | GPa | 10⁶ psi | MPa | kpsi | MPa | kpsi | kV/cm | kV/in. | W/m-k | h-n²-° F. | 10⁻⁶/K | wt % |
| Solid rod and | 2.00 | 690 | 100 | 41.4 | 6.0 | 690 | 100 | 410 | 60 | 23.60 | 60 | 0.288 | 2.0 | 5.4 | 0.3 |
| bar, 70% | | | | | | | | | | | | | | | |
| Unidirectional | | | | | | | | | | | | | | | |
| reinforcement | | | | | | | | | | | | | | | |
| Profiles, 50% | 1.80 | 207 | 30 | 17.2 | 2.5 | 207 | 30 | 276 | 40 | 9.84 | 25 | 0.144 | 1.0 | 9.0 | 0.5 |
| Multi- | | | | | | | | | | | | | | | |
| directional | | | | | | | | | | | | | | | |
| reinforcement | | | | | | | | | | | | | | | |

(a)The axial properties given are typical of those attainable through the pultrusion process. Variations in glass content and orientation, as well as modifications to the resin system, can improve these properties. Composite systems can be developed to meet many customized physical, mechanical, electrical, flame-resistant, and environmental properties.

Frequently, the decision to be made relates to composite selection as an alternative to such traditional materials as steel, aluminum, or wood. Selected relative properties of common alternative materials are listed in Table 3. Table 3 compares various materials in terms of absolute strength or stiffness.

TABLE 3
Material properties comparison

| | Property | | | | | |
|---|---|---|---|---|---|---|
| | Tensile | | | | Flexural | |
| | strength | | Rigidity | | Strength | |
| Material | MPa | kpsi | GPa | 10⁶ psi | MPa | kpsi |
| Wood | | | | | | |
| Maple | 100 | 15 | 12.4 | 1.80 | 55 | 8 |
| Pine | 60 | 9 | 12.1 | 1.75 | 35 | 5 |
| Thermoplastics | | | | | | |
| Reinforced (typical) | 55 | 8 | 3.4 | 0.5 | 55 | 8 |
| Glass reinforced (typical) | 100 | 15 | 6.9 | 1.0 | 140 | 20 |
| FRP pultrusions | | | | | | |
| 50% mat and roving | 280 | 40 | 21 | 3.0 | 210 | 30 |
| 70% roving only | 690 | 100 | 41 | 6.0 | 550 | 80 |
| Metals | | | | | | |
| Aluminum | 280 | 40 | 70 | 10 | 280 | 40 |
| Steel | 690 | 100 | 210 | 30 | 690 | 100 |

The thermal conductivity of composites reflects both matrix and fiber characteristics. Generally, the fiberglass-reinforced composites are excellent insulators for thermal and electrical environments. This is also true of the organic fiber composites, regardless of the matrix employed. The use of conductive carbon fibers, however, results in composites that exhibit greater thermal and electrical conductivity; this reduces their effectiveness as insulators (although they are still efficient relative to metals) but creates opportunities because of their static and heat dissipation characteristics.

Although fiberglass-reinforced composites display a modest positive coefficient of thermal expansion, both aramid- and carbon-reinforced composites display a slightly negative coefficient of thermal expansion. This characteristic can be used to advantage in aerospace structures and in producing very tight tolerance parts. The same characteristics can result in molded-in stresses in multidirectional reinforcement systems, particularly if dissimilar fiber types (hybrids) are used. Carbon-reinforced composites are also noted for their lubricity and wear resistance, which makes them suitable for use as bearing materials. Their capacity for heat dissipation is advantageous in this application.

The impact resistance of organic fiber reinforced composites is quite high, making them suitable for energy absorption applications.

Chemical and corrosion resistance characteristics of composite reinforcements are predominantly attributed to the resin matrix. In considering a particular resin system for an intended environment, the degree of exposure, the concentration of the corrosive element, and the temperature of the environment must be known.

Of the glass fibers available, C-glass is by far the best in all-around chemical resistance, while ECR glass (modified E-glass) is excellent in most acids. AR glass is alkaline resistant and is desirable when a cementitious matrix is used. Standard E-glass is relatively inferior in acidic and alkaline environments, and A-glass is poor in water resistance. Standard E-Glass is the most popular and is available in pultrusion rovings and mats; some C-glass veil is used for surface coverage. Aramid fibers are resistant to fuels, solvents, and lubricants and are superior to glass fibers in many strong acids and bases. Carbon/graphite fibers are resistant to alkaline and salt solutions, but are subject to attack by strong oxidizing agents and halogenated chemicals, particularly at elevated temperatures. It is important, therefore, to consider the chemical resistance aspects of both the reinforcement and the matrix when considering the application of any composite material in corrosive environments.

The disclosed pultrusion-extrusion process can produce virtually any shape that can be extruded. The part must be consistent in cross section over its length. Tapered shapes cannot be produced and must be post processed, machined or molded. Some curved shapes have been reported, but generally, the equipment required for this activity differs from a standard pultrusion machine. Any length can be produced that can be transported.

Any fiber reinforcement can be used in the process, although fiberglass, carbon, aramid, and thermoplastic fibers are most frequently selected. All of these materials are available in commingled yams, roving, axial, biaxial, and woven fabrics, and in random-oriented mats. In addition, fine-fiber mats can be used at the surface of any part produced. Except for the differing thermal conductivity rates that should be considered, any of these materials can be used together in hybrid composites.

The preferred composite reinforcement for this invention employs Twintex® direct roving, woven roving, pellets or consolidated sheets available from Vetrotex CertainTeed. Sample properties for the consolidate sheets are shown below in Table 4, below.

TABLE 4
Physical Properties for Twintex ® Fabric

| Property¹ | | | Average Values | | STD |
|---|---|---|---|---|---|
| Tensile Strength² | Warp (1) | σ11 | 287.62 | mpa | 30.35 |
| | | | 41.70 | kpsi | 4.40 |
| | Weft (2) | σ12 | 265.86 | mpa | 24.14 |
| | | | 38.4 | kpsi | 3.5 |
| Tensile Modulus | Warp (1) | E11 | 13.79 | gpa | 0.14 |
| | | | 2.00 | msi | 0.02 |
| | Weft (2) | E22 | 12.97 | gpa | 0.69 |
| | | | 1.88 | msi | 0.10 |
| Poisson's Ratio | Biaxial (12) | v12 | 0.10 | | 0.01 |
| | Biaxial (21) | v21 | 0.12 | | 0.00 |
| Compression Strength³ | Warp (1) | σ11 | 154.05 | mpa | 17.93 |
| | | | 22.40 | kpsi | 2.60 |
| | Weft (2) | σ22 | 151.05 | mpa | 13.79 |
| | | | 21.90 | kpsi | 2.00 |
| Compression Modulus³ | Warp (1) | E11 | 15.86 | gpa | 1.38 |
| | | | 2.30 | msi | 0.20 |
| | Weft (2) | E22 | 15.17 | gpa | 0.48 |
| | | | 2.20 | msi | 0.07 |
| Shear Strength⁴ | Biaxial (12) | τ12 | 18.83 | mpa | 1.52 |
| | | | 2.73 | kpsi | 0.22 |
| | Biaxial (21) | τ21 | 17.80 | mpa | 0.69 |
| | | | 2.58 | kpsi | 0.10 |
| | Through the | τ13 | 13.66 | mpa | 0.97 |
| | Thickness (13) | | 1.98 | kpsi | 0.14 |
| | Through the | τ23 | 12.14 | mpa | 0.97 |
| | Thickness (23) | | 1.76 | kpsi | 0.14 |
| Shear Modulus⁴ | Biaxial (12) | G12 | 1.72 | gpa | 0.21 |
| | | | 0.25 | msi | 0.03 |
| | Biaxial (21) | G21 | 1.59 | gpa | 0.21 |
| | | | 0.23 | msi | 0.03 |
| | Through the | G13 | 1.79 | gpa | 0.14 |
| | Thickness (13) | | 0.26 | msi | 0.02 |
| | Through the | G23 | 1.66 | gpa | 0.76 |
| | Thickness (23) | | 0.24 | msi | 0.11 |
| Tsia-Wu Interaction⁵ | Biaxial (12) | F12 | −1.00E−09 | 1/mpa\hat{ }2 | 1.69E−11 |
| | | | −4.76E−08 | 1/psi\hat{ }2 | 2.23E−09 |
| Coefficient of | Warp (1) | CTE 1 | 5.44E−06 | m/m/C | 4.69E−11 |
| Thermal Expansion⁶ | | | 9.80E−06 | in./in./F | 3.05E−07 |
| | Weft (2) | CTE 2 | 6.28E−06 | m/m/C | 2.69E−07 |
| | | | 1.13E−05 | in./in./F | 4.84E−07 |

| | | | |
|---|---|---|---|
| Through the | CTE3 | 1.078E−06T + 7.478E−05 | m/m/C |
| Thickness (3) | | 3.326E−07T + 3.090E−05 | in./in./F |

Footnotes For Table 4
¹Test panels were prepared from Twintex ® fabric product TPEAT4460K, which has the
following characteristics:

| | |
|---|---|
| Weight, % Glass | 60% |
| Weight, % Polypropylene | 40% |
| Areal Weight | 1486 g/m² (44 oz./yd.²) |
| Nominal Molded Fabric Thickness | 1 mm (0.040 in.) |
| Fabric Construction | 10 ends/in. × 5 double ends/in. |
| Weave Type | Balanced 2 × 2 Twill |
| Color | Black |

Twintex ® panels were prepared at Vetrotex America by molding multiple layers of
Twintex ® fabric. The fabric was placed between two, thin stainless-steel platens and heated
in a 410° F. (210°C.) press at a pressure of 450 kpa. When the middle of the fabric stack
reached 400° F. (205° C.), the platens and fabric were transferred to a cold press and cooled
to room temperature at a pressure of 1380 kpa. For each specific test, specimens were cut
from the above panels and tabbed by technicians at the University of Wyoming Composites
Research Group.
²Tensile tests were performed per ASTM D3039 in both warp (1) and weft (2) directions.
Specimens were nominally 2-mm thick and strain was measured by a biaxial extensometer.
The tests were performed at a crosshead speed of 0.05 in./min.
³Compression tests were performed per ASTM D3410 in both the warp (1) and weft (2)
directions. Test specimens were 2.5 cm wide by 12.5 cm long, with a nominal thickness of
5 mm. Specimens were instrumented with back-to-back strain gauges. Tests were performed
using an IITRI fixture with flame-sprayed wedge grips on universal test machining at a
crosshead speed of 0.05 in./min.
⁴In-Plane and Interlaminar Shear Tests were performed per ASTM D5379, the Losipescu
Shear Test Method. In-Plane shear tests (G12, G21) were performed on specimens with a
nominal thickness of 5 mm. Specimens were instrumented with strain gauges and tested in
a universal test machine at crosshead speed of 0.05 in./min. Interlaminar shear tests (G13,
G23) were performed on specimens made by bonding multiple panels together and then cross
sectioned to obtain the through the thickness properties using the Losipescu Shear Test
Method.
⁵Test specimens were cut 10 degrees off axis and tested in tension using moment-reducing
rotating grips. The Tsia-Wu Interaction Term F12 was calculated from the failure stress using
the Tsia-Wu tensor failure theory.
⁶Thermal expansion measurements were made using a quartz tube dilatometer to measure the
length change in an environment chamber. Test specimens for the warp (1) direction and weft
(2) direction were 2-mm nominal thickness. The through the thickness measurement (3) was
performed on an 18-mm-thick panel. Samples were heated to 150° F. (65° C.) and cooled
to relax any stresses before testing. The test was performed from - 110° F. (−45° C.) to
150° F. (65° C). The through the thickness coefficient of thermal expansion was found to be
non-linear and is represented as a function of temperature.

Twintex® roving is a unique thermoplastic roving consisting of commingled unidirectional thermoplastic and glass fibers. By intimately blending glass and thermoplastic filaments within the roving, Twintex® roving has solved the problem of economically impregnating continuous glass fibers with thermoplastic resins.

Twintex® roving is composed of fine, homogeneous commingled continuous glass filaments and thermoplastic filaments. It ensures easy, consistent processing with heat and low pressure, since it is a dry composite prepreg. Twintex® roving combines the positive aspects of both thermoplastic materials and glass fiber-reinforced thermoset matrix composite materials, and reconciles the excellent mechanical properties of continuous glass fiber-reinforced materials with the processing ease of thermoplastic materials. It also provides excellent impact resistance. Twintex® products are available with polypropylene matrix (PP), with glass loadings of 60% and 75% by weight.

The following Twintex® products are available:

Direct Roving

60% glass by weight—265 yield (1875 tex)

75% glass by weight—330 yield (1500 tex)

Available in natural and black

Inside or outside pull

Packaging styles: Bulk pack or open top boxes, 36 or 48 rovings per pallet

Woven Roving

60% glass by weight only

22 oz. or 44 oz. balanced fabric

Plain weave or 2×2 twill

27 oz. 4:1 unbalanced fabric

Available in natural or black

Packaging style depends on roll length

Minimum orders apply

Pellets

75% glass

Natural color only

Available lengths: ½″, 1″, 1½″

Packaging styles: 1,000 lb. Gaylord boxes

Consolidated Sheets

60% glass

Available in natural or black

Customized lengths

Customized laminates

Minimum orders apply

Twintex® commingled roving is made of glass and polypropylene fibers. The unique commingled structure of Twintex® roving makes it easy for the polypropylene resin to wet out the glass fibers in a variety of processes to make continuous fiber composites. These processes vary from low-pressure processes such as vacuum molding, filament winding and pultrusion, to high-pressure processes found in compression molding and co-molding. Twintex® roving is easily converted into composites by heating the material above the melting point of PP 392° F. (200° C.) to 428° F. (220° C.). The polypropylene flows under pressure to form the matrix of the composites. Vacuum Molding is used to make large composite Twintex® roving parts with a one-sided tool and a vacuum bag to form the component. This process is similar to vacuum bagging for thermoset composites. Silicone reusable membranes also can be used.

Key Vacuum Molding Processing Points:

Position Twintex® on an open-faced mold.

Place a vacuum bag over the Twintex® and seal the material to the mold.

Remove the air from the bag, sandwiching the Twintex® between the bag and the mold.

Heat mold to achieve material temperature of 392° F. (200° C.).

Cool the part to below 212° F. (100° C.).

Filament winding is used to produce composite structures by winding Twintex® rovings over a rotating mandrel.

Key Filament Winding Processing Points:

Rovings are pulled from a package through a tensioning device and into an infrared or convection oven to heat the mandrel to 392° F. (200° C.) to 428° F. (220° C.).

A guide-eye positions the molten Twintex® rovings onto the rotating mandrel, forming the composite.

Pultrusion is the process of pulling continuous fibers through a die or rollers to produce constant profile composites.

Key Pultrusion Processing Points:

Rovings are pulled from a package through a tensioning device and into an infrared or convection oven to heat the material to 392° F. (200° C.) to 428° F. (220° C.).

The molten Twintex® rovings are drawn through a series of dies or rollers to consolidate and form the composites.

Extrusion compression molding uses a plasticator to transform Twintex® pellets and polypropylene (“PP”) pellets into a hot bulk molding compound.

Key Extrusion Compression Molding Processing Points:

Mix Twintex® and polypropylene pellets into a blender mounted in the extruder hopper.

Transport the molten charge quickly to the press and place it in the mold.

Close the mold rapidly.

Remove the part from the mold after sufficient cooling to 212° F. (100° C.).

Co-molding consists of using Twintex® woven roving or consolidated sheets with a flowing material like GMT, PP sheet stock or thermoplastic bulk molding compound (TPBMC). TPBMC can be further reinforced with Twintex® pellets. Co-molded parts benefit from the use of continuous glass fibers for increased toughness and durability, and from the use of the flowing material, which allows for increased design freedom and lowers cost.

Key Co-Molding Processing Points:

Control tool temperature between 60° F. (15° C.) and 212° F. (100° C.).

Heat Twintex® to 392° C. (200° C.) to 428° F. (220° C.) in an infrared or convection oven.

Transport the molten Twintex® from the oven to the mold rapidly to prevent the polypropylene matrix from cooling prior to mold closing.

Position molten flowable polypropylene material into the mold corresponding to the thicker areas of the part.

Close mold rapidly to ensure parts are formed prior to polypropylene solidification.

Remove part from mold after part has cooled.

Panel lamination converts Twintex® wovens with or without core materials into flat panels continuously. Core panels include PP, honeycomb, foam, wood and extruded plastics.

Key Panel Lamination Processing Points:

Feed all materials into a double belt laminator.

Allow machine to heat, impregnate and cool down the panel.

Thermoforming stamping is a low-pressure process that uses consolidated sheet.

Key Thermoforming Stamping Processing Points:

Cool temperature to approximately 176° F. (80° C.).

Heat Twintex® to 392° F. (200° C.) to 428° F. (220° C.) in an infrared convection oven.

Transport the molten Twintex® from the oven to mold to prevent the polypropylene matrix from cooling prior to mold closing (10 seconds).

Close mold (>60 mm per second) to ensure that parts are formed prior to polypropylene solidification.

Remove part from mold after part has cooled to below 212° F. (100° C.).

Thermoplastic light cores can be added in the stamping (compression) process to form three-dimensional sandwich structures.

Diaphragm forming uses sheets of reusable silicone as a carrier for Twintex® fabrics between a hot platen section and a forming section. The process transforms Twintex® fabrics into parts with very low air pressure. The one side of the tooling remains cold and is therefore extremely inexpensive.

Key Diaphragm Processing Points:

Insert Twintex® fabrics between two silicone sheets.

Place the silicone/Twintex® sandwich in the hot platen equipment until it reaches a temperature of 410° F. (210° C.).

Transfer the forming unit and apply positive air pressure (30 psi).

Demold when the part and silicone are below 212° F. (100° C.).

Remove silicone membranes from the part before reuse.

This invention will be further understood with respect to he following Examples.

### EXAMPLE A

Accelerated Weathering Testing

A 60° C. black panel accelerated weathering test was used to evaluate color stability of a fencing material. Test samples of a composite of black polypropylene capstock extruded onto a pultruded thermoplastic polypropylene/glass fiber Twintex® composite were placed in a xenon arc weatherometer (Model 65 DMC-WR, manufactured by Atlas Electric Devices, Chicago, Ill.) Test panels were 1.5″×6″ with the black surface exposed to the light source with a radiance of 0.35 W/m². The test cycle was 51 minutes of exposure to light followed by 9 minutes of light with a water spray having a water temperature of 4.4° C. The exposure cycle was continued for 7000 hours with periodic removal of samples for color measurement.

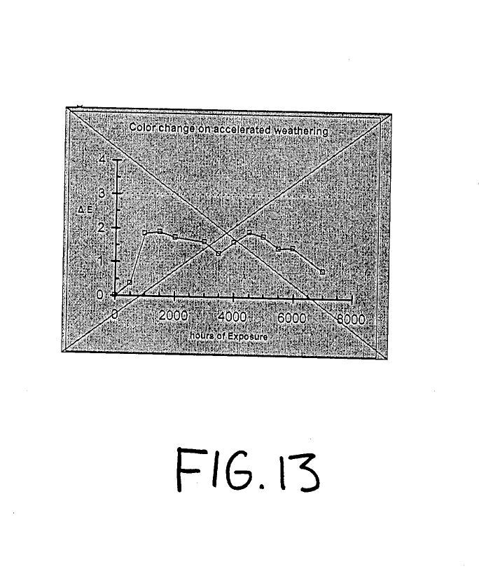

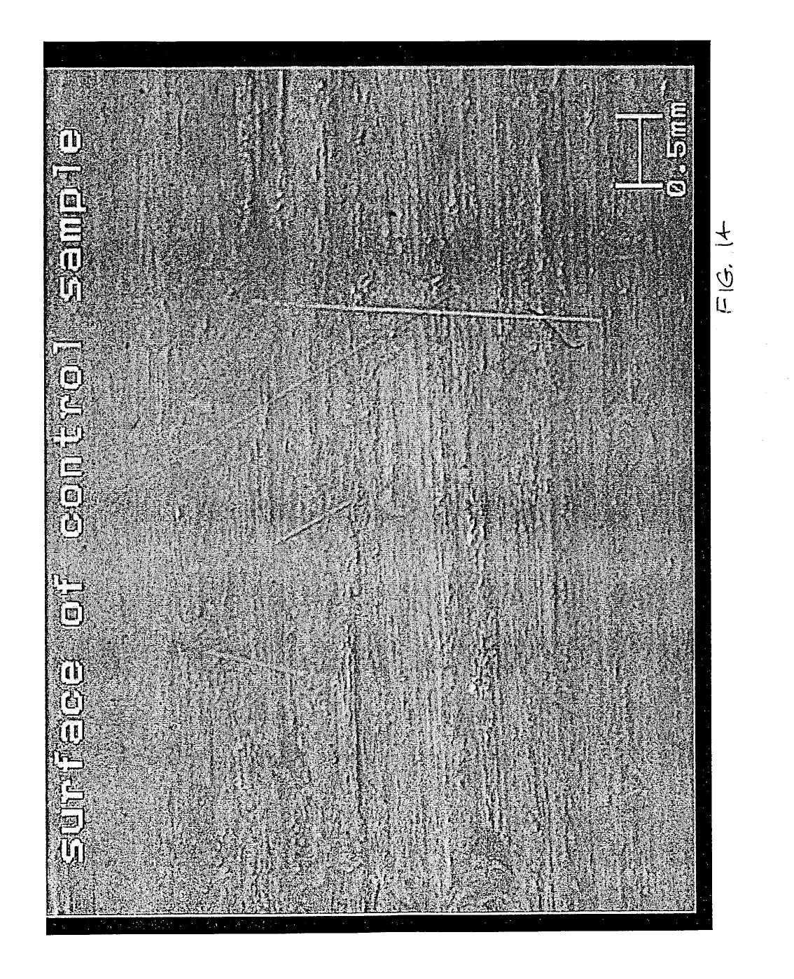

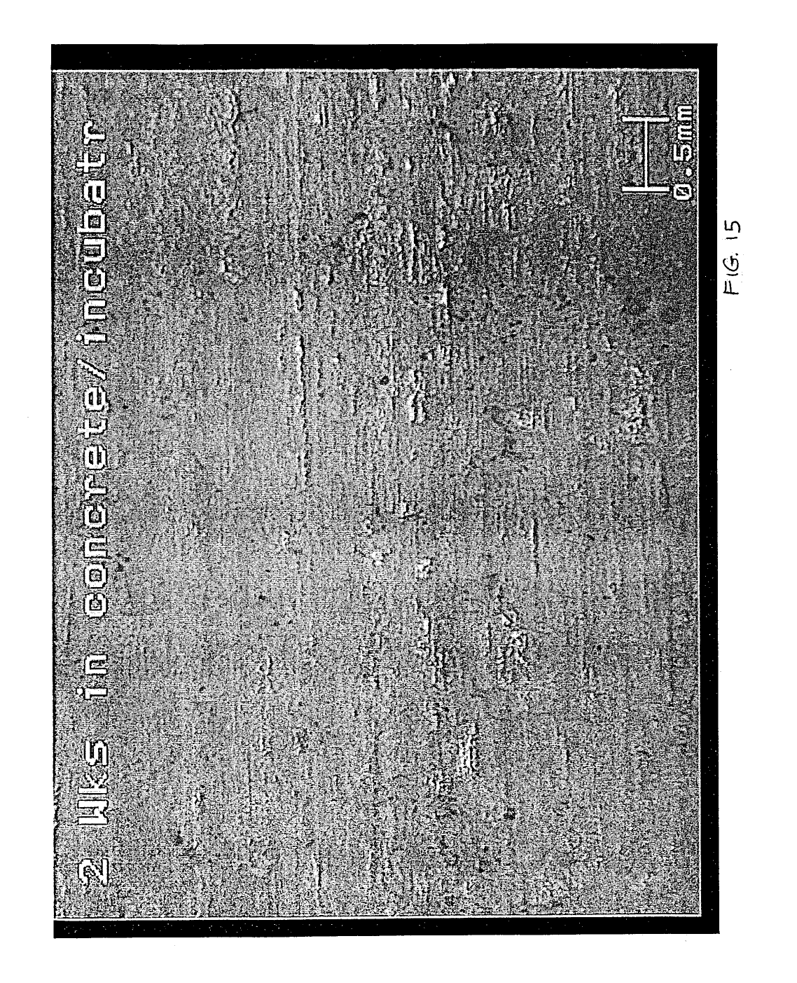

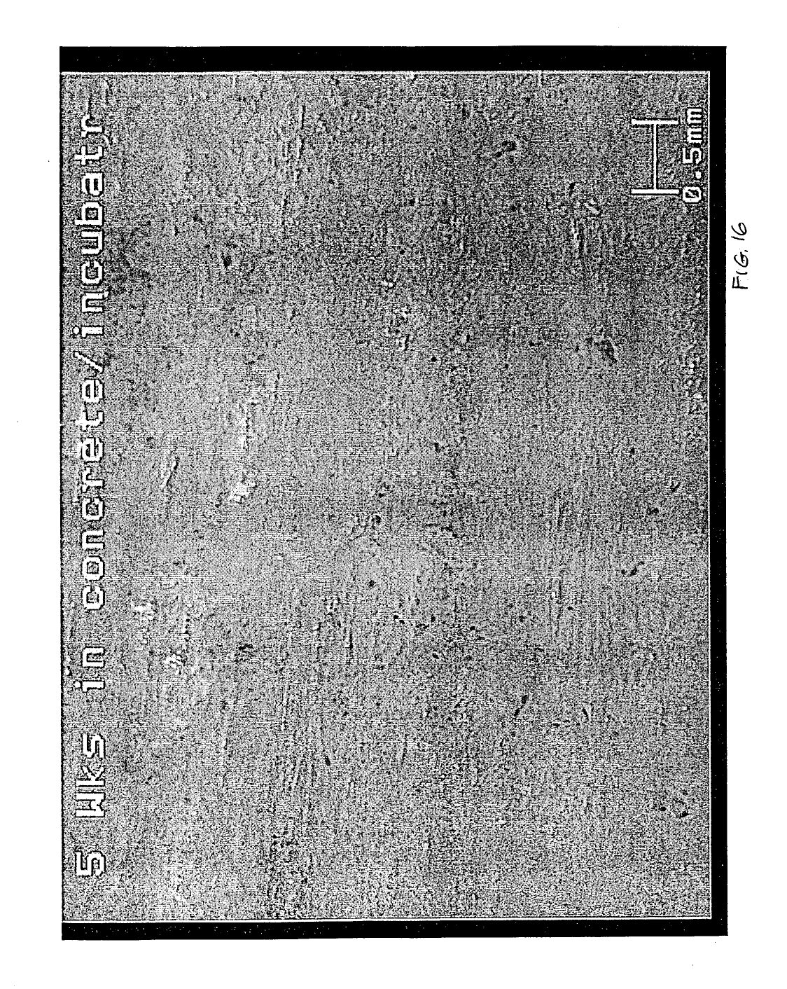

Color was measured using a Hunter LabScan Xe (available from Hunter Associates Laboratories, Inc., Reston, Va.). Illumination and viewing geometry was 0°/45° with a 2° Standard Observer. Color was reported in CIE 1976 L*a*b* units. The total color difference ΔE was calculated as [(ΔL)²⁺Δa*)²+(Δb*)²]^{1/2} with the changes relative to the initial color. Color change on accelerated weathering exposure is shown in Table 5. FIG. 13 shows the total color change over time. Also shown in FIG. 13 is a line at ΔE=3, the minimum level of color difference detectable by typical human color perception. The ΔE for the test samples was less than 2 for all samples. Also, if the black color were fading to a lighter shade, one would expect the L value to increase, and it did not.

TABLE 5

| Hours | L* | a* | b* | ΔE |
|---|---|---|---|---|
| 0 | 16.6 | 0 | −0.93 | 0.000 |
| 500 | 16.24 | −0.030 | −0.990 | 0.366 |
| 1000 | 14.78 | 0.040 | −0.650 | 1.842 |
| 1500 | 14.73 | 0.020 | −0.660 | 1.889 |
| 2000 | 14.88 | 0.040 | −0.760 | 1.729 |
| 3000 | 14.98 | 0.060 | −0.8500 | 1.623 |
| 3500 | 15.33 | 0.000 | −0.920 | 1.270 |
| 4000 | 14.98 | 0.000 | −0.980 | 1.621 |
| 4500 | 14.93 | 0.020 | 0.020 | 1.921 |
| 5000 | 14.83 | −0.010 | −1.110 | 1.779 |
| 5500 | 15.17 | −0.060 | −1.110 | 1.443 |
| 6000 | 15.17 | −0.070 | −1.220 | 1.461 |
| 7000 | 15.84 | −0.250 | −0.990 | 0.802 |

### EXAMPLE B

Accelerated Concrete Exposure Testing

In one application of the invention, the base ends of fence posts are embedded in concrete footings to provide for mechanical stability of a fence structure. Common hydraulic cements and concrete compositions are known to be alkaline in nature. Alkaline environments can be corrosive to inorganic glasses such as, for example, the glass fibers that make up a part of the composite building material of the invention. In order to evaluate the chemical stability of the composite in contact with concrete chemistries, an accelerated test was performed.

Flat strip samples of the composite 0.5″×6″ were cut from a pultruded Prestige™ rail, from Bufftech, Buffalo, N.Y., the commercial embodiment of the present invention consisting of Twintex® consolidated roving and a black polypropylene capstock. The strip samples were placed with the glass fiber side in contact with the concrete surface of a bed of freshly mixed Portland cement concrete, commercially obtained from a home improvement store, and the black capstock side facing away from the concrete surface. The concrete had been mixed according to the package instructions. The concrete was allowed to harden with the glass fiber side of the flat strip test samples in contact with the concrete surface as it cured. The concrete with the samples attached was placed in an incubator and subjected to conditions of 140° F. and 100% relative humidity for accelerated testing. Samples were removed from the incubator at 2, 5, 8 and 11 week exposure times and analyzed using microscopy and mechanical testing. While not wanting to be bound by theory, this accelerated testing is thought to correspond to at least about 20 years of concrete contact in the ground.

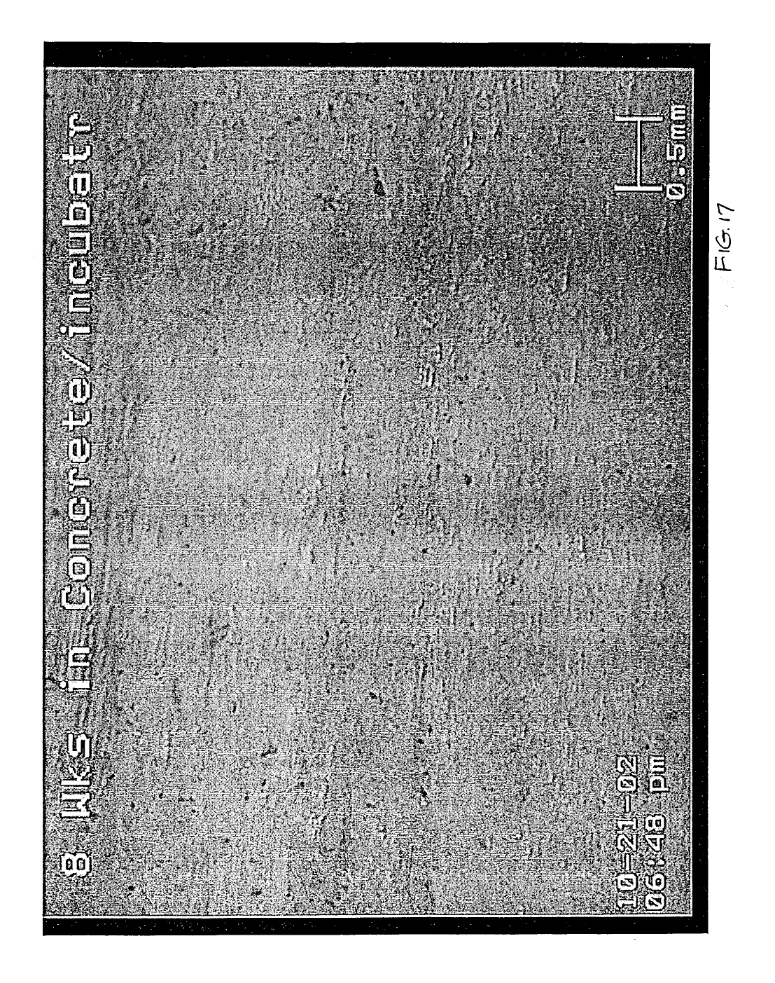

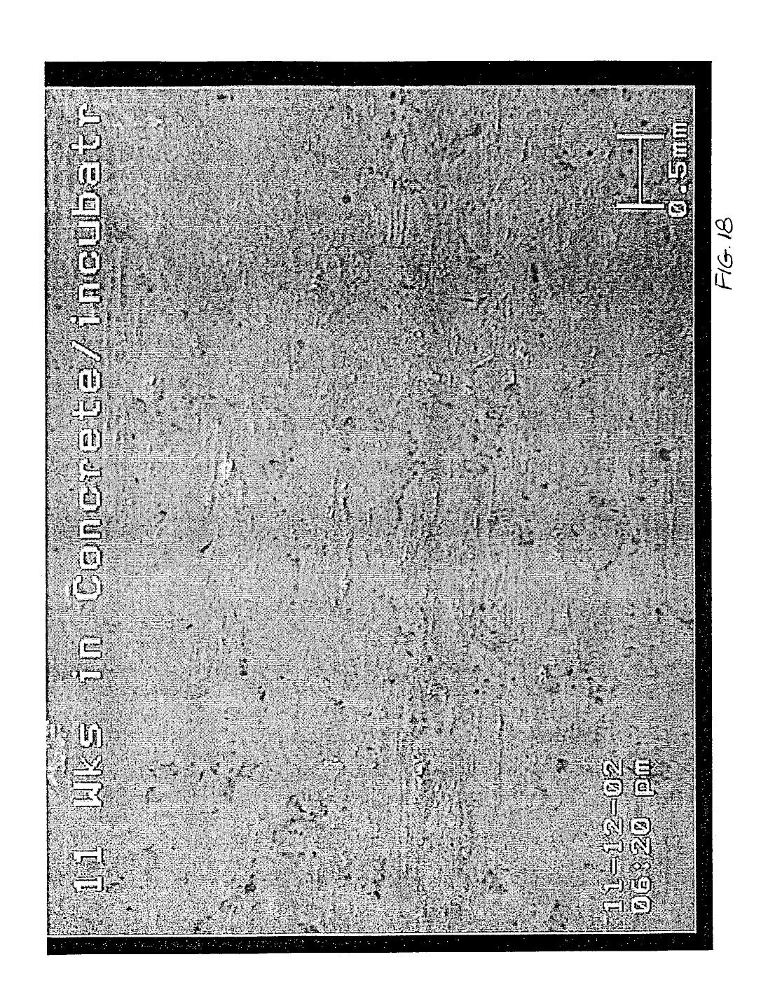

The glass fiber side of the flat strip samples was inspected for evidence of degradation, cracks or any other changes. No change was noted. Micrographs were taken of representative areas of the sample and are shown in FIGS. 14, 15, 16, 17 and 18, for 0, 2, 5, 8 and 11 week exposures, respectively. The legend indicates a dimension of 0.5 mm for scale.

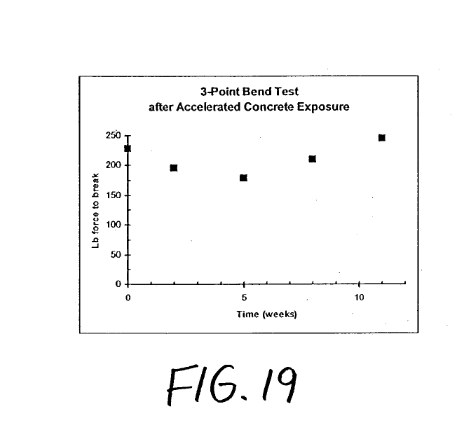

A three point bend test was performed on the samples at ambient laboratory conditions. To perform the test, a sample was placed flat on supports 4″ apart with a free length of 1″ on either end. A mechanical tester was used to apply a load to the center of the midsection of the test sample at a speed of 0.2″/min. The force was measured as the sample was bent to break. Average test data from three measurements are reported in Table 6 for each of the accelerated exposure test conditions. FIG. 19 shows that the bend strength did not change substantially over 11 weeks of exposure to concrete at 140° F. and 100% relative humidity.

TABLE 6
Three Point Bend Test after Accelerated Concrete Exposure:

| Weeks of | |
|---|---|
| concrete exposure | Lbs force to break |
| 0 | 228.8 |
| 2 | 196.2 |
| 5 | 179.2 |
| 8 | 210.3 |
| 11 | 245.6 |

### EXAMPLE C

A Prestige™ fence, substantially like Example B, an aluminum fence, and steel fence were exposed to a motorized weed trimmer in a normal pass, as one would do in edge trimming a lawn on a good weather day. The effect of the impact of the weed trimmer's cutting string on the fencing materials was observed. The coatings on the aluminum and steel fences were scratched significantly by the weed trimmer. The Prestige™ fence sample looked substantially the same after exposure to the weed trimmer as it did before contact.

We claim:

1. A polymer composite building material comprising:
a composite reinforcement comprising continuous filaments of fibers substantially oriented in at least a first direction within a polymeric matrix, said composite reinforcement having a higher tensile strength and a lower rigidity than aluminum; and
a capstock polymeric material disposed substantially over said composite reinforcement;
said building material being resistant to heat deformation and corrosion.

2. The building material of claim 1 wherein at least said capstock has a dark pigment.

3. The building material of claim 2 wherein said heat deformation resistance includes resistance to bowing due to expansion and contraction of said building material when exposed to sunlight.

4. The building material of claim 3 wherein said composite reinforcement and said capstock are observably discrete portions of said building material.

5. The building material of claim 1, wherein said composite reinforcement comprises about 50-95 wt. % fiber content.

6. The building material of claim 5 wherein said fibers comprise one or more of:
glass, aramid or carbon fibers.

7. The building material of claim 1 wherein said resistance to corrosion includes resistance to chemical gasses, acids, or alkaline environments.

8. The building material of claim 1 in which the building material is in the form of a fence, rail, post, or decking component.

9. The building material of claim 1 wherein said composite reinforcement has a tensile strength greater than 40 Kpsi (280 MPa), and a rigidity of lower than about 10×10⁶ psi (70 GPa).

10. The building material of claim 1 wherein said composite reinforcement has a tensile strength of greater than about 500 MPa and a rigidity greater than 30 GPa.

11. The building material of claim 1 wherein said composite reinforcement and said capstock are joined by a melt or interdiffusional bond.

12. The building material of claim 11 wherein said polymeric matrix and said capstock polymeric material comprise a thermoplastic resin.

13. The building material of claim 11 wherein said polymeric matrix and said capstock polymeric material each comprises a resin, and said resin is the same resin.

14. The building material of claim 13 wherein said same resin comprises polypropylene.

15. The building material of claim 13 wherein the three point bend load to failure for said building material is substantially unaffected when exposed to a concrete mix for at least five weeks.

16. The building material of claim 1 wherein said building material is resistant to scratching when contacted by the cutting string of a motorized weed trimmer.

17. The building material of claim 1 wherein said building material has a total color difference ΔE of less than 3 units using CIE 1976 L*a*b* scale when exposed to at least 1000 hours of a 0.35 w/m² radiant light source applied in light test cycles of 51 minutes followed by 9 minutes of light with a water spray.

18. A polymer composite building material comprising:
a composite reinforcement comprising glass filaments oriented in at least a first direction within a thermoplastic resin matrix, and a capstock polymeric material comprising a thermoplastic resin and a dark pigment melt bonded to said composite reinforcement, said composite reinforcement having a tensile strength of greater than about 180 MPa and a rigidity of lower than about 70 GPa, said capstock polymeric material being resistant to corrosion to chemical gasses, acids or alkaline environments, and said building material being resistant to heat deformation due to sunlight exposure.

19. A polymer composite fencing component comprising:
a composite reinforcement comprising continuous filaments of fibers oriented substantially in at least a first longitudinal direction within a polymeric matrix, said composite reinforcement having a tensile strength greater than about 280 MPa and a rigidity lower than about 70 GPa; and
a capstock polymeric material containing a dark pigment disposed substantially over said composite reinforcement;
said fencing component being resistant to corrosion and heat deformation due to exposure to sunlight.

20. The fencing component of claim 19 wherein said composite reinforcement comprises one or more of: roving, fabric or tape.

21. The fencing component of claim 20 wherein said fabric comprises a uni-directional, multi-axial or woven material.

22. The fencing component of claim 19 wherein said composite reinforcement comprises a pultrusion.

23. The fencing component of claim 19 wherein said polymeric matrix comprises a thermoplastic resin.

24. The fencing component of claim 19 wherein said composite reinforcement comprises about 50-95% fiber content.

25. The fencing component of claim 24 wherein said continuous filaments of fibers comprise glass roving.

26. The fencing component of claim 25 wherein said continuous filaments of fibers comprise fibers oriented in a second direction.

27. The fencing component of claim 19 wherein said component has an unsupported span of at least about 8 feet.

28. The fencing component of claim 19 wherein the three point bend load to failure for said fencing component is substantially unaffected when exposed to a concrete mix for at least five weeks.

29. The fencing component of claim 19 wherein said fencing component is resistant to scratching when contacted by the cutting string of a motorized weed whacker.

30. The fencing component of claim 19 wherein said fencing component has a total color difference ΔE of less than 3 units using the CIE 1976 L*a*b* scale when exposed to at least 1000 hours of a 0.35 w/m² radiant light source applied in test cycles of 51 minutes followed by 9 minutes of light with a water spray.

31. A method of making a polymer composite building material comprising:
forming a composite reinforcement comprising continuous filaments of fibers oriented substantially in at least a first direction within a polymeric matrix;
disposing a capstock polymeric material substantially over said composite reinforcement; and
cutting said composite reinforcement and said overlaying capstock polymeric material to a desired length.

32. The method of claim 31 wherein said forming step comprises a pultrusion step.

33. The method of claim 32 wherein said pultrusion step comprises pultruding a commingled roving.

34. The method of claim 33 wherein said commingled roving comprises said continuous filaments of fibers and a fibrous precursor of said polymeric matrix.

35. The method of claim 34 wherein said continuous filaments of fibers comprise glass fibers and said fibrous precursor of said polymeric matrix comprises thermoplastic fibers.

36. The method of claim 31 wherein said disposing step comprises extruding said capstock polymer over said composite reinforcement.

37. The method of claim 31 wherein said forming step comprises pultruding said continuous filaments of fibers and a precursor of said polymeric matrix, and said disposing step comprises extruding said capstock polymeric material over said pultruded composite reinforcement.

38. The method of claim 37 wherein said pultrusion and extrusion steps are conducted in-line.

39. The method of claim 32 wherein said forming step comprises heating said fibers and a precursor of said polymeric matrix prior to said pultrusion step.

40. A polymer composite building material comprising:
a composite reinforcement comprising continuous glass filaments of fibers substantially oriented in at least a first direction within a thermoplastic polymeric matrix, said composite reinforcement having a higher tensile strength than aluminum; and
a capstock polymeric material having a dark pigment disposed substantially over said composite reinforcement;
said building material being corrosion resistant to chemical gasses or acids, resistant to bowing due to expansion and contraction of said building material upon exposure to sunlight, and resistant to a set alkaline cementitious mix for a prolonged period of time.

41. A method of making a polymer composite fencing component comprising:
forming a composite reinforcement comprising continuous filaments of fibers oriented in at least a longitudinal direction within a polymeric matrix;
disposing a capstock polymeric material substantially over said composite reinforcement; and
cutting said composite reinforcement and said overlaying capstock polymeric material to a desired length.

42. The method of claim 41, wherein said forming step comprises consolidating commingled, continuous filaments of glass fibers and polymeric fibers.

43. The method of claim 42, wherein the step of consolidation of said commingled fibers is conducted in-situ during in-line manufacturing of said fencing component.

44. The method of claim 42, wherein the step of consolidation of said commingled fibers forms a tape or rod.

45. The method of claim 42, wherein the commingled, continuous filaments of glass fibers and polymeric fibers are incorporated through a cross-die head to form a polymer extrudate.

46. The method of claim 42, wherein the commingled, continuous filaments contain glass fibers dispersed uniformly in a longitudinal direction.

47. The method of claim 41, wherein the composite reinforcement includes about 40%-90% glass fiber content.

48. The method of claim 41 wherein composite reinforcement comprises a bulk molding compound.

49. The method of claim 48, wherein said bulk molding compound comprises commingled, continuous filaments of glass fibers and polymeric fibers.

50. The method of claim 41 further comprising orienting said continuous filaments in a transverse or helical direction.
